(19) United States
(12) Patent Application Publication
(10) Pub. No.: US 2007/0080638 A1
(43) Pub. Date: Apr. 12, 2007

(54) PLASMA DISPLAY PANEL

(75) Inventors: Chung Hoo Park, Yeonje-gu, Busan (KR); Seong Nam Ryu, Sasang-gu, Busan (KR); Joon Young Choi, Saha-gu, Busan (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/276,347

(22) Filed: Feb. 24, 2006

(30) Foreign Application Priority Data
Sep. 13, 2005 (KR) 1020050085461

(51) Int. Cl. H01J 17/49

(52) U.S. Cl. 313/582; 313/586; 313/587

(57) ABSTRACT

The present invention relates to a plasma display panel including electrodes. In the plasma display panel according to an embodiment of the present invention, an area of a scan electrode is larger than that of a sustain electrode. Therefore, a jitter characteristic improves.

### CROSS-REFERENCES TO RELATED APPLICATIONS

This Nonprovisional application claims priority under 35 U.S.C. § 119(a) on Patent Application No. 10-2005-0085461 filed in Korea on Sep. 13, 2005 the entire contents of which are hereby incorporated by reference.

### BACKGROUND OF THE INVENTION

1. Field of the Invention

The present document relates to a plasma display panel.

2. Background of the Related Art

A general plasma display panel comprises a plurality of barrier ribs that are formed between a front panel and a rear panel and partition discharge cells. A plurality of discharge cells forms one pixel. For example, a red (R) cell, a green (G) cell and a blue (B) cell form one pixel.

Each discharge cell is filled with an inert gas containing a primary discharge gas, such as neon (Ne), helium (He) or a mixed gas of Ne+He, and a small amount of xenon (Xe). If a high frequency voltage discharges the inert gas, vacuum ultraviolet rays are radiated. Vacuum ultraviolet rays excite phosphors formed within the discharge cell, so that images are implemented. The plasma display panel can be manufactured to be thin, and has thus been considered one of the next-generation display devices.

FIG. 1 shows the arrangement of electrodes formed on a plasma display panel in the related art.

As shown in FIG. 1, the related art plasma display panel 100 has scan electrodes Y1 to Yn and sustain electrodes Z1 to Zn that are parallel to each other, and address electrodes X1 to Xm intersecting the scan electrodes Y1 to Yn and the sustain electrodes Z1 to Zn.

Each of discharge cells is formed at a point where the scan electrodes Y1 to Yn, the sustain electrodes Z1 to Zn and the address electrodes X1 to Xm intersect, i.e., in a region A. Accordingly, the discharge cells are formed in a matrix form.

In the structure of the electrodes formed in the related art plasma display panel, when driving the plasma display panel, a discharge starts late. Therefore, a problem arises in that a discharge times become prolonged, i.e., a problem whereby a jitter characteristic deteriorates. A delayed discharge due to a worsened jitter characteristic adversely effects the next discharge, thereby resulting in an erroneous discharge.

FIG. 2 is a graph illustrating characteristics of an address discharge in the electrode structure of the plasma display panel in the related art. In order for the scan electrodes and the address electrodes of FIG. 1 to select a discharge cell where a display discharge will be generated, an address discharge is performed in the address period. FIG. 2 shows an optical waveform that appears as a pulse is applied to each discharge cell to generate the address discharge. FIG. 2 shows a consistent time of an optical waveform of 500 address discharges that are consecutively generated. That is, FIG. 2 shows that when driving the related art plasma display panel, the time from when the address discharges are sequentially generated for every discharge cell beginning from a time point where a pulse for a first address discharge is applied to the discharge cell to when the last address discharge is generated is approximately 2.5 μs. The reason why a jitter characteristic, i.e., such a delayed discharge occurs can have its origin in several causes. For example, a jitter characteristic may deteriorate due to a difference in an amount of wall charges between electrodes, a weak discharge between electrodes is generated, inaccuracy of a discharge between target electrodes and/or the like.

### SUMMARY OF THE INVENTION

Accordingly, an object of the present invention is to solve at least the problems and disadvantages of the background art.

It is an object of the present invention to provide a plasma display panel in which an erroneous discharge is prevented and the accuracy of a discharge increases.

It is another object of the present invention to provide a plasma display panel in which a jitter characteristic improves.

It is further another object of the present invention to provide a plasma display panel in which driving efficiency can be enhanced.

A plasma display panel according to an aspect of the present invention comprises a plurality of barrier ribs disposed on a substrate to form a discharge cell, a scan electrode with a first area in a region within the discharge cell, and a sustain electrode with a second area smaller than the first area in the region within the discharge cell.

A plasma display panel according to another aspect of the present invention comprises a plurality of barrier ribs disposed on a substrate to form a discharge cell, a scan electrode comprising a scan bus electrode with a first area and a scan transparent electrode with a second area in a region within the discharge cell, and a sustain electrode comprising a sustain bus electrode with a third area smaller than the first area and a sustain transparent electrode with a fourth area smaller than the second area in the region within the discharge cell.

A plasma display panel according to further another aspect of the present invention comprises a plurality of barrier ribs disposed on a substrate to form a discharge cell, a scan bus electrode formed in a region within the discharge cell, a scan transparent electrode comprising a first portion scan electrode connected to the scan bus electrode and a second portion scan electrode vertically connected to the first portion scan electrode, a sustain bus electrode formed in the region within the discharge cell, and a sustain transparent electrode comprising a first portion sustain electrode connected to the sustain bus electrode and a second portion sustain electrode vertically connected to the first portion sustain electrode. A total width of the first portion scan electrode and the second portion scan electrode is wider than the total width of the first portion sustain electrode and the second portion sustain electrode.

The plasma display panel according to embodiment of the present invention is advantageous in that a discharge is more effectively generated and the accuracy of a discharge increases.

The plasma display panel according to an embodiment of the present invention is advantageous in that it improves a jitter characteristic.

The plasma display panel according to an embodiment of the present invention has an advantage in that it enhances the driving efficiency of the panel.

The plasma display panel according to an embodiment of the present invention is advantageous in that it improves luminance.

### BRIEF DESCRIPTION OF THE DRAWINGS

The invention will be described in detail with reference to the following drawings in which like numerals refer to like elements.

FIG. 1 shows the arrangement of electrodes formed on a plasma display panel in the related art;

FIG. 2 is a graph illustrating characteristics of an address discharge in the electrode structure of the plasma display panel in the related art;

FIG. 3 shows the construction of a plasma display panel according to an embodiment of the present invention;

FIG. 4 illustrates a method of implementing gray levels of an image of the plasma display panel according to an embodiment of the present invention;

FIG. 5 shows a driving waveform depending on a method of driving the plasma display panel according to an embodiment of the present invention;

FIG. 6 shows an electrode structure of a plasma display panel according to a first embodiment of the present invention;

FIG. 7 is a graph illustrating variations in a jitter characteristic when an electrode width is controlled according to a first embodiment of the present invention;

FIGS. 8a and 8b show a barrier rib structure of the plasma display panel according to an embodiment of the present invention;

FIG. 9 shows an electrode structure of a plasma display panel according to a second embodiment of the present invention;

FIG. 10 shows an electrode structure of a plasma display panel according to a third embodiment of the present invention;

FIG. 11 is a graph illustrating characteristics of an address discharge generated in the plasma display panel according to an embodiment of the present invention;

FIG. 12 is a graph illustrating the results of comparing a discharge voltage characteristic of the electrode structure of the plasma display panel according to an embodiment of the present invention and a discharge voltage characteristic of the plasma display panel in the related art;

FIG. 13a illustrates a discharge current characteristic depending on a sustain voltage (applied voltage) in the electrode structure in the related art;

FIG. 13b illustrates a discharge current characteristic depending on a sustain voltage (applied voltage) in the electrode structure of the present invention;

FIG. 14 shows an electrode structure of a plasma display panel according to a fourth embodiment of the present invention;

FIG. 15 shows an electrode structure of a plasma display panel according to a fifth embodiment of the present invention;

FIG. 16 shows an electrode structure of a plasma display panel according to a sixth embodiment of the present invention;

FIG. 17 shows an electrode structure of a plasma display panel according to a seventh embodiment of the present invention;

FIG. 18 shows an electrode structure of a plasma display panel according to an eighth embodiment of the present invention;

FIG. 19 shows an electrode structure of a plasma display panel according to a ninth embodiment of the present invention; and

FIG. 20 shows an electrode structure of a plasma display panel according to a tenth embodiment of the present invention.

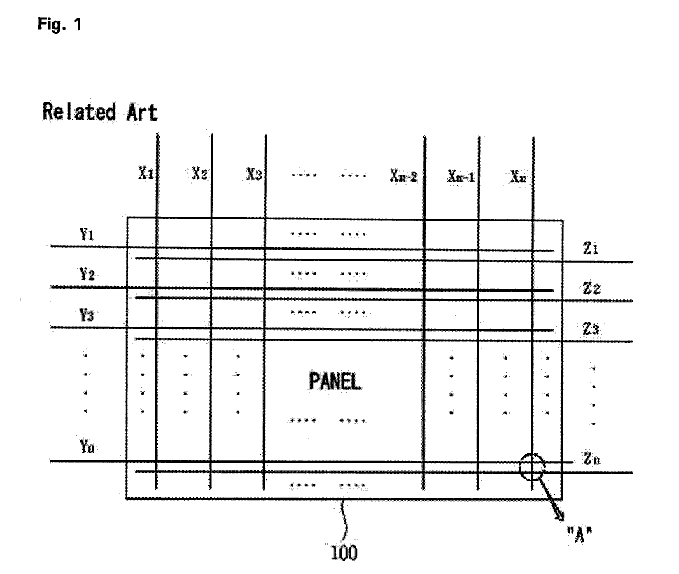

### DETAILED DESCRIPTION OF THE PREFERRED EMBODIMENT

Preferred embodiments of the present invention will be described in a more detailed manner with reference to the drawings.

A plasma display panel according to an aspect of the present invention comprises a plurality of barrier ribs disposed on a substrate to form a discharge cell, a scan electrode with a first area in a region within the discharge cell, and a sustain electrode with a second area smaller than the first area in the region within the discharge cell.

A first width of the scan electrode in the first portion of the discharge cell may be wider than a second width of the sustain electrode in the second portion of the discharge cell.

The difference between the first width and the second width may be 5% or more to 50% or less.

The difference between the first width and the second width may be 10% or more to 30% or less.

The first width may be a maximum value of a width of the scan electrode and the second width may be a maximum value of a width of the sustain electrode.

The scan electrode comprises a scan transparent electrode and the sustain electrode may comprise a sustain transparent electrode. The width of the scan transparent electrode may be the first width. The width of the sustain transparent electrode may be the second width.

The plurality of barrier ribs may comprise first barrier ribs that partition the discharge cell and an adjacent discharge cell in which different phosphors are formed. The scan transparent electrode and the sustain transparent electrode may protrude in a direction toward the first barrier ribs.

The plurality of barrier ribs may comprise second barrier ribs that partition the discharge cell and an adjacent discharge cell in which the same phosphor is formed. An exhaust groove may be formed on the second barrier ribs.

The plurality of barrier ribs may comprise first barrier ribs that partition the discharge cell and an adjacent discharge cell in which different phosphors are formed. The plasma display panel may further comprise an address electrode intersecting the scan electrode and the sustain electrode. The address electrode may protrude in a direction of the first barrier ribs in a region corresponding to the scan electrode.

The scan electrode may comprise a scan bus electrode with the first area in the region within the discharge cell. The sustain electrode may comprise a sustain bus electrode with the second area in the region within the discharge cell. The scan bus electrode and the sustain bus electrode may form a discharge gap.

A first width of the scan bus electrode in the region within the discharge cell may be wider than a second width of the sustain bus electrode in the region within the discharge cell.

The difference between the first width and the second width may be 5% or more to 50% or less.

The difference between the first width and the second width may be 10% or more to 30% or less.

The plurality of barrier ribs may comprise second barrier ribs that partition discharge cell and an adjacent discharge cell in which the same phosphor is formed. An exhaust groove may be formed on the second barrier ribs.

The plasma display panel may further comprise a scan transparent electrode connected to the scan bus electrode, and an address electrode intersecting the scan bus electrode and the scan transparent electrode. The plurality of barrier ribs may comprise first barrier ribs that partition the discharge cell and an adjacent discharge cell in which different phosphors are formed. The address electrode protrudes in a direction toward the first barrier ribs in a region corresponding to the scan bus electrode and the scan transparent electrode.

A plasma display panel according to another aspect of the present invention comprises a plurality of barrier ribs disposed on a substrate to form a discharge cell, a scan electrode comprising a scan bus electrode with a first area and a scan transparent electrode with a second area in a region within the discharge cell, and a sustain electrode comprising a sustain bus electrode with a third area smaller than the first area and a sustain transparent electrode with a fourth area smaller than the second area in the region within the discharge cell.

The plurality of barrier ribs may comprise second barrier ribs that partition the discharge cell and an adjacent discharge cell in which the same phosphor is formed, and wherein an exhaust groove is formed on the second barrier ribs.

A plasma display panel according to further another aspect of the present invention comprises a plurality of barrier ribs disposed on a substrate to form a discharge cell, a scan bus electrode formed in a region within the discharge cell, a scan transparent electrode comprising a first portion scan electrode connected to the scan bus electrode and a second portion scan electrode vertically connected to the first portion scan electrode, a sustain bus electrode formed in the region within the discharge cell, and a sustain transparent electrode comprising a first portion sustain electrode connected to the sustain bus electrode and a second portion sustain electrode vertically connected to the first portion sustain electrode. A total width of the first portion scan electrode and the second portion scan electrode is wider than the total width of the first portion sustain electrode and the second portion sustain electrode.

The plurality of barrier ribs may comprise first barrier ribs that partition the discharge cell and an adjacent discharge cell in which different phosphors are formed. The plasma display panel may further comprise an address electrode intersecting the scan transparent electrode. The address electrode may protrude in a direction toward the first barrier ribs in a region corresponding to the scan transparent electrode.

Detailed embodiments of the present invention will now be described with reference to the accompanying drawings.

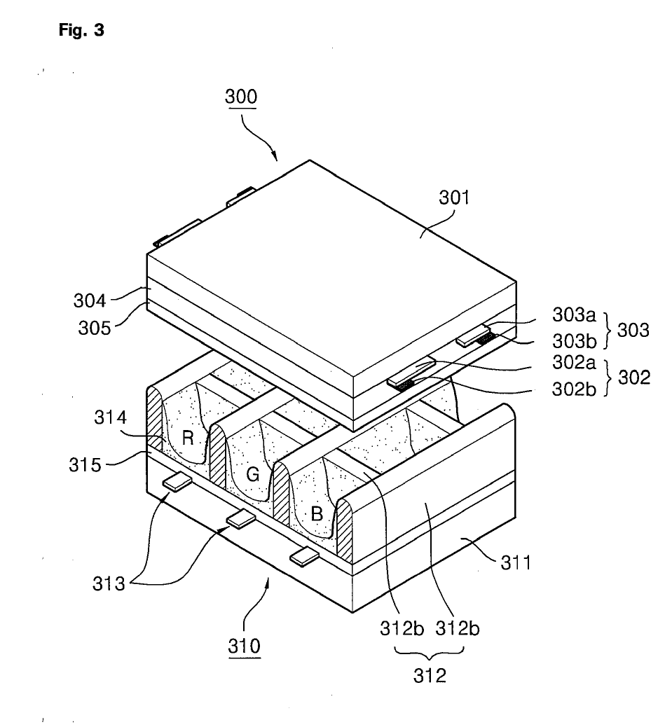

FIG. 3 shows the construction of a plasma display panel according to an embodiment of the present invention. As shown in FIG. 3, the plasma display panel according to an embodiment of the present invention comprises a front panel 300 in which a scan electrode 302 and a sustain electrode 303 are arranged on a front substrate 301 on which images are displayed, and a rear panel 310 in which address electrode 313 intersecting the scan electrode 302 and the sustain electrode 303 are arranged on a rear substrate 311.

The scan electrode 302 comprises a transparent electrode 302a comprising a transparent ITO material and a bus electrode 302b comprising a metal material. The sustain electrode 303 also comprises a transparent electrode 303a comprising a transparent ITO material and a bus electrode 303b comprising a metal material.

The scan electrode 302 and the sustain electrode 303 are covered with one or more upper dielectric layers 304 that limit a discharge current and provide insulation between electrode pairs. A protection layer 305 having deposited Magnesium Oxide (MgO) thereon is formed on a top surface of the upper dielectric layer 304 to facilitate discharge conditions.

The rear panel 310 comprises address electrode 313 formed on the rear substrate 311, for performing address discharge to generated vacuum ultraviolet rays. A lower dielectric layer 315 for protecting the address electrode 313 is formed on the address electrode 313. A plurality of barrier ribs 312 for forming discharge cells are formed on the lower dielectric layer 315. Phosphor 314 that radiates a visible ray to display images is coated between one barrier rib and the other barrier rib. Each of the plurality of barrier ribs 312 comprises a first barrier rib 312a that partitions a discharge cell in which different phosphors are formed, and a second barrier rib 312b that partitions a discharge cell in which the same phosphor is formed.

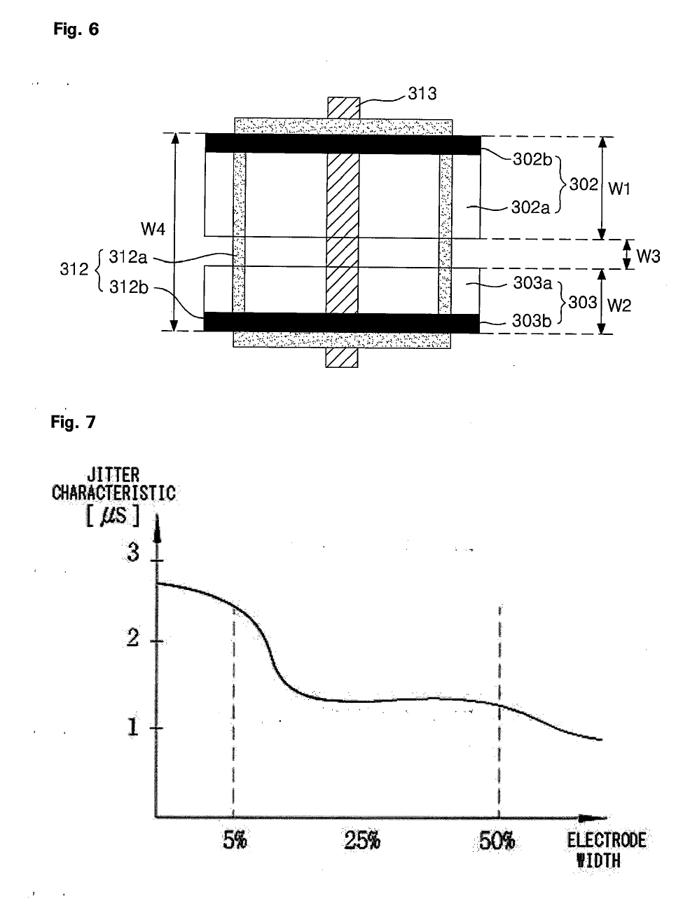

The scan electrode 302 of the plasma display panel according to an embodiment of the present invention has a first area in a region within the discharge cell. The sustain electrode 303 has a second area smaller than the first area in a region within the discharge cell. This will be described in detail later on with reference to FIG. 6.

An example of the structure of the plasma display panel according to an embodiment of the present invention is shown in FIG. 3. Therefore, the present invention is not limited to the electrode structure of FIG. 3. Furthermore, one or more of the scan electrode 302 and the sustain electrode 303 can consist of only a bus electrode.

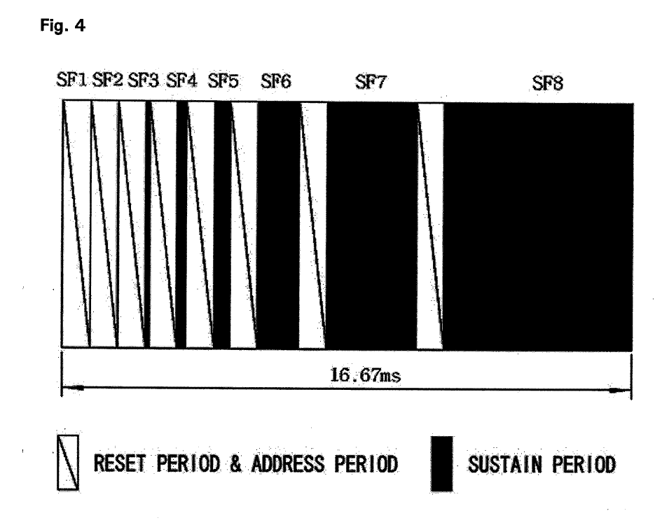

A method of representing gray levels of an image in the plasma display panel according to an embodiment of the present invention will be described below with reference to FIG. 4.

FIG. 4 illustrates a method of implementing gray levels of an image of the plasma display panel according to an embodiment of the present invention. As shown in FIG. 4, in the method of implementing gray levels of an image in the plasma display panel of the present invention, one frame is divided into several sub-fields, each having a predetermined number of emission. Each of the sub-fields is again divided into a reset period (RPD) for initializing all of the cells, an address period (APD) for selecting a discharge cell to be discharged, and a sustain period (SPD) for implementing gray levels depending on a discharge number. For example, to display images with 256 gray levels, a frame period (16.67 ms) corresponding to 1/60 seconds is divided into eight sub-fields (SF1 to SF8) as shown in FIG. 4. Each of the eight sub-fields (SF1 to SF8) is again divided into a reset period, an address period and a sustain period.

The reset period and the address period of each sub-field are the same for every sub-field. An address discharge for selecting a discharge cell to be discharged is generated because of a voltage difference between the address electrodes and the scan electrodes, i.e., transparent electrodes. The sustain period increases in the ratio of 2ⁿ (where n=0, 1, 2, 3, 4, 5, 6, 7) in each sub-field. Since a sustain period is different in each sub-field as described above, gray levels of an image are represented by controlling a sustain period of each sub-field, i.e., a sustain discharge number.

The case where one frame is divided into eight sub-fields has been described in FIG. 4. However, the number of sub-fields constituting one frame can be varied. For example, one frame can include twelve sub-fields from a first sub-field to a twelfth sub-field. Furthermore, ten sub-fields can constitute one frame.

It has also been shown in FIG. 4 that the sub-fields are arranged in order in which the amount of gray level weights increases in one frame. However, sub-fields can be arranged in order decreasing gray level weights in one frame, or sub-fields can be arranged regardless of their gray level weights.

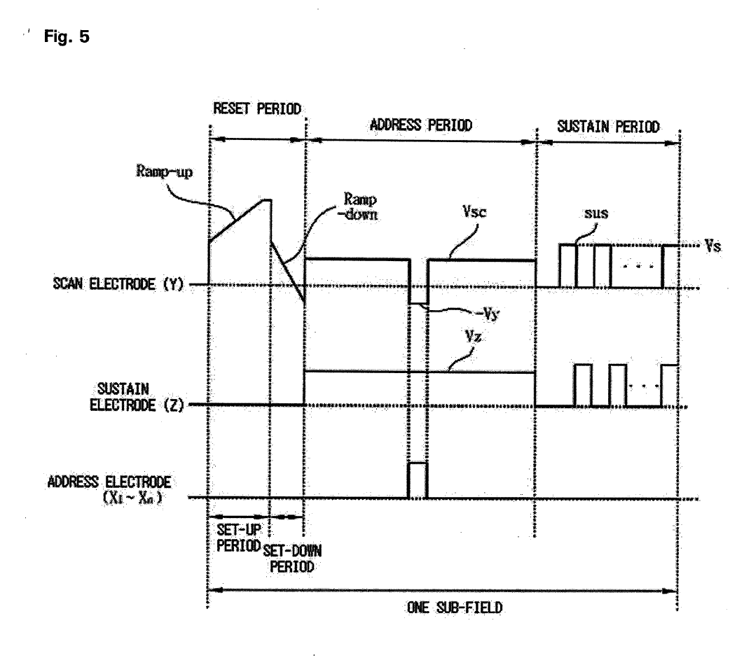

A driving waveform depending on the driving method of the plasma display panel according to the present invention, in which gray levels of an image are implemented through the method, will now be described with reference to FIG. 5.

FIG. 5 shows a driving waveform depending on a driving method of the plasma display panel according to an embodiment of the present invention. As shown in FIG. 5, the plasma display apparatus is driven with one frame being divided into a reset period for initializing all of the cells, an address period for selecting cells to be discharged, and a sustain period for sustaining the discharge of selected cells. Furthermore, an erase period for erasing wall charges within discharged cells can be added, if appropriate.

In a set-up period of the reset period, a ramp-up waveform (Ramp-up) is applied to all of the scan electrodes at the same time. The ramp-up waveform generates a weak dark discharge within the discharge cells of the entire screen. The set-up discharge also causes positive wall charges to be accumulated on the address electrodes and the sustain electrodes and negative wall charges to be accumulated on the scan electrodes.

In a set-down period of the reset period, after the ramp-up waveform is supplied, a ramp-down waveform (Ramp-down), which falls from a positive voltage lower than a peak voltage of the ramp-up voltage to a predetermined voltage level lower than a ground (GND) level voltage, generates a weak erase discharge within the cells, so that wall charges excessively formed on the scan electrodes are sufficiently erased. The set-down discharge causes wall charges of the degree in which an address discharge can be stably generated to uniformly remain within the cells.

In the address period, while negative scan signals are sequentially applied to the scan electrodes, a positive data signal is applied to the address electrodes in synchronization with the scan signal. As a voltage difference between the scan signal and the data signal and a wall voltage generated in the reset period are added, an address discharge is generated within discharge cells to which the data signal is applied. Furthermore, wall charges of the degree in which a discharge can be generated when a sustain voltage (Vs) is applied are formed within cells selected by the address discharge. During the set-down period and the address period, the sustain electrodes are supplied with a positive voltage (Vz) such that an erroneous discharge is not generated between the sustain electrodes and the scan electrodes by reducing a voltage difference between the sustain electrodes and the scan electrodes.

In the sustain period, a sustain signal is alternately applied to the scan electrodes and the sustain electrodes. As a wall voltage within the cells and the sustain signal are added, a sustain discharge, i.e., a display discharge is generated between the scan electrodes and the sustain electrodes in the cells selected by the address discharge whenever the sustain signal is applied.

After the sustain discharge is completed, if the apparatus is driven by adding the erase period for erasing wall charges within discharged cells, a voltage of an erase ramp pulse (Rampers) having a narrow pulse width and a low voltage level is applied to the sustain electrode in the erase period. Therefore, wall charges remaining within the cells of the entire screen are erased.

The electrode structure of the plasma display panel, which has an important effects on the several discharges as described above, according to an embodiment of the present invention will be described in detail below with reference to FIG. 6.

FIG. 6 shows an electrode structure of a plasma display panel according to a first embodiment of the present invention. As shown in FIG. 6, the plasma display panel according to a first embodiment of the present invention comprises a scan electrode 302 and a sustain electrode 303 for sustaining emission in a discharge cell.

The scan electrode 302 comprises a scan transparent electrode 302a comprising a transparent material and a scan bus electrode 302b comprising a metal material. The sustain electrode 303 comprises a sustain transparent electrode 303a comprising a transparent material and a sustain bus electrode 303b comprising a metal material.

The plasma display panel according to a first embodiment of the present invention further comprises an address electrode 313 intersecting the scan electrode 302 or the sustain electrode 303. A discharge cell is formed at a region where the scan electrode 302 or the sustain electrode 303 intersects the address electrode 313.

The electrode structure corresponding to one discharge cell has been shown in FIG. 6 in detail. A first width (W1) in the longitudinal direction of the address electrode 313 of the scan transparent electrode 302a is wider than a second width (W2) in the longitudinal direction of the address electrode 313 of the sustain transparent electrode 303a, in a region within the discharge cell.

The first width (W1) is 5% to 50% wider than the second width (W2). More particularly, the width (W1) in the longitudinal direction of the address electrode 313 of the scan transparent electrode 302a is 10% to 30% wider than the width (W2) in the longitudinal direction of the address electrode 313 of the sustain transparent electrode 303.

If the width of the electrodes is not constant, the first width (W1) and the second width (W2) can be defined to be a width up to the greatest projection portion of the scan transparent electrode 302a and the sustain transparent electrode 303a.

The reason why the width of the scan transparent electrode 302a is set to be more than the width of the sustain transparent electrode 303a is to improve a discharge characteristic. That is, an address discharge is generated by a voltage applied to the scan electrode 302 and the address electrode 313. Therefore, if the width of the scan transparent electrode 302a is more than the width of the sustain transparent electrode 303a, an overlapping area between the scan transparent electrode 302a and the address electrode 313 increases. This can lead to an improved jitter characteristic, i.e., a discharge delay characteristic.

Furthermore, more wall charges are accumulated on the scan electrode 302 in a reset discharge occurring in the reset period where all of the discharge cells are initialized. Therefore, an address discharge of the address period is more easily generated. Accordingly, a jitter characteristic improves.

FIG. 7 is a graph illustrating variations in a jitter characteristic when an electrode width is controlled according to a first embodiment of the present invention. There is shown in FIG. 7 that a jitter characteristic improves when the width of the scan electrode is 5% to 50% wider than width of the sustain electrode according to a first embodiment of the present invention.

When the width of the scan electrode is 5% less than the sustain electrode, the jitter characteristic improved a little. When the width of the scan electrode is 50% more than the sustain electrode, the jitter characteristic significantly improved. In this case, however, the asymmetry between the scan electrode and the sustain electrode becomes worse and a sustain discharge is not uniformly generated. This results in a deteriorating driving characteristic.

Based on the fact, the width (W1) in the longitudinal direction of the address electrode 313 of the scan transparent electrode 302a is 10% to 30% wider than the width (W2) in the longitudinal direction of the address electrode 313 of the sustain transparent electrode 303a.

A spaced distance (W3) between the scan transparent electrode 302a and the sustain transparent electrode 303a is 60 μm or higher. The spaced distance (W3) is required such that a stable sustain discharge can be generated between the scan electrode 302 and the sustain electrode 303.

Furthermore, the size of a discharge cell, which is an important factor in discharge conditions, can be controlled. A width in the longitudinal direction of the address electrode 313 of the discharge cell, i.e., an inner width (W4) of the discharge cell other than the second barrier rib 312b in FIG. 6 can be set to 600 μm or higher.

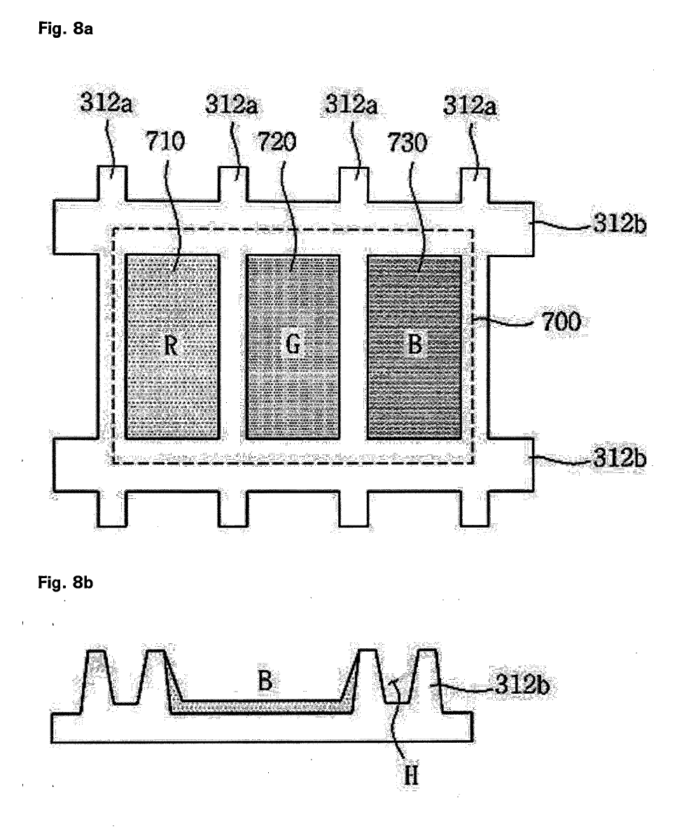

Furthermore, an exhaust groove can be formed on the barrier ribs that partition the discharge cells, as shown in FIGS. 8a and 8b.

FIGS. 8a and 8b show a barrier rib structure of the plasma display panel according to an embodiment of the present invention. As shown in FIG. 8a, a red discharge cell 710, a green discharge cell 720 and a blue discharge cell 730 gather to form one pixel 700. The discharge cells 710, 720 and 730 are partitioned by a plurality of barrier ribs 312. An exhaust groove (H) with a groove can be formed in second barrier rib 312b partitioning the discharge cells in which the same phosphor is formed.

The exhaust groove (H) improves an exhaust characteristic of the plasma display panel. The exhaust groove (H) reduces capacitance formed by the second barrier rib 312b. That is, since the exhaust groove (H) comprises a groove, capacitance formed by the second barrier rib 312b reduces. Accordingly, a driving voltage of the plasma display panel is lowered and driving efficiency is enhanced.

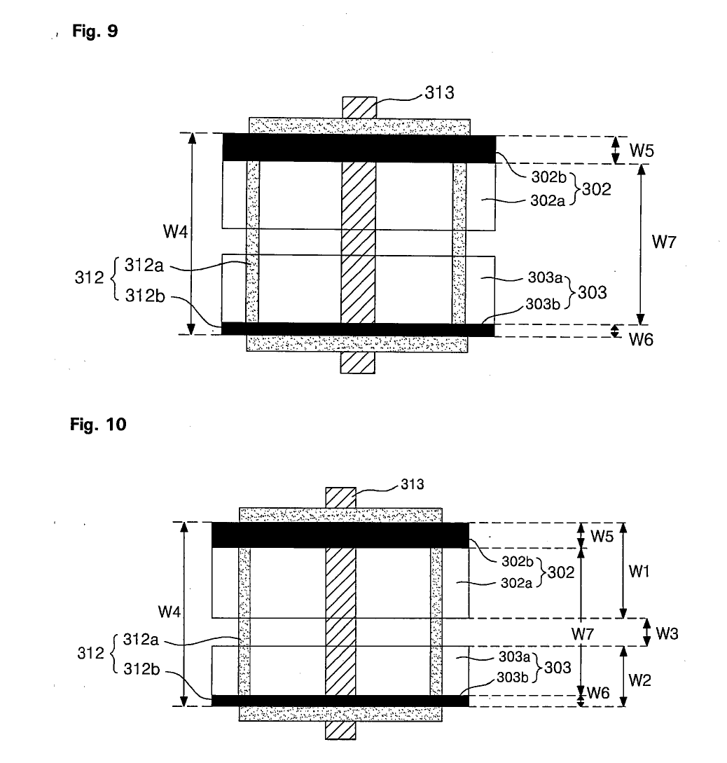

FIG. 9 shows an electrode structure of a plasma display panel according to a second embodiment of the present invention. As shown in FIG. 9, a plasma display panel according to a second embodiment of the present invention comprises a scan electrode 302 and a sustain electrode 303 for sustaining the emission of a discharge cell. That is, the scan electrode 302 comprises a scan transparent electrode 302a comprising a transparent material and a scan bus electrode 302b comprising a metal material. The sustain electrode 303 comprises a sustain transparent electrode 303a comprising a transparent material and a sustain bus electrode 303b comprising a metal material.

The scan transparent electrode 302a and the sustain bus electrode 303a are shown in FIG. 9. However, the second embodiment of the present invention can be implemented using only the scan bus electrode 302b and the sustain bus electrode 303b without the scan transparent electrode 302a and the sustain bus electrode 303a.

The plasma display panel according to a second embodiment of the present invention further comprises an address electrode 313 intersecting the scan electrode 302 or the sustain electrode 303. A discharge cell is formed at a location where the scan electrode 302 or the sustain electrode 303 intersects the address electrode 313.

In FIG. 9, a first width (W5) in the longitudinal direction of the address electrode 313 of the scan bus electrode 302b is set to be wider than a second width (W6) in the longitudinal direction of the address electrode 313 of the sustain bus electrode 303b, in a region within the discharge cell.

That is, for example, the first width (W5) is formed 5% to 50% wider than the second width (W6). The first width (W5) in the longitudinal direction of the address electrode 313 of the scan bus electrode 302b is formed 10% to 30% wider than the second width (W6) in the longitudinal direction of the address electrode 313 of the sustain bus electrode 303.

reason why the width of the scan bus electrode 302b is wider than the width of the sustain bus electrode 303b is to improve a jitter characteristic by preventing a discharge delay. That is, as described above with reference to FIG. 7, if the width of the scan bus electrode 302b is 5% less than the width of the sustain bus electrode 303b, a jitter characteristic slightly improves. However, if the width of the scan bus electrode 302b is 50% or higher than the width of the sustain bus electrode 303b, a jitter characteristic significantly improves. However, the asymmetry between the scan bus electrode 302b and the sustain bus electrode 302a will deteriorate and a sustain discharge will not be uniformly generated.

The width (W5) in the longitudinal direction of the address electrode 313 of the scan bus electrode 302b and the width (W6) in the longitudinal direction of the address electrode 313 of the sustain bus electrode 303b is formed to be at least 50 μm or more to secure the driving margin of the plasma display panel.

To stably generate a stable sustain discharge between the scan electrode 302 and the sustain electrode 303 and to enhance discharge efficiency, a spaced distance (W7) between the scan bus electrode 302b and the sustain bus electrode 303b set to 200 μm or more.

To reduce consumption power against luminance due to the reduction of a discharge space and to enhance driving efficiency of the plasma display panel, an inner width (W4) of the discharge cell other than the second barrier rib 312b is set to 600 μm or more.

Furthermore, an exhaust groove can be formed in the barrier ribs partitioning in the discharge cell. The exhaust groove has been described with reference to FIG. 8. Therefore, description thereof will be omitted to avoid redundancy.

FIG. 10 shows an electrode structure of a plasma display panel according to a third embodiment of the present invention. As shown in FIG. 10, a width (W1) in the longitudinal direction of an address electrode 313 of a scan transparent electrode 302a is formed wider than a width (W2) in the longitudinal direction of the address electrode 313 of a sustain transparent electrode 303a. A width (W5) in the longitudinal direction of the address electrode 313 of a scan bus electrode 302b is formed wider than a width (W6) in the longitudinal direction of the address electrode 313 of a sustain bus electrode 303b. The scan transparent electrode 302a and the sustain transparent electrode 303a and the scan bus electrode 302b and the sustain bus electrode 303b have been described in detail above. Therefore, description thereof will be omitted to avoid redundancy.

As described above, the plasma display panel of the present invention can improve a jitter characteristic by controlling the width of electrodes. The advantages of the present invention will be described below in more detail with reference to the accompanying drawings.

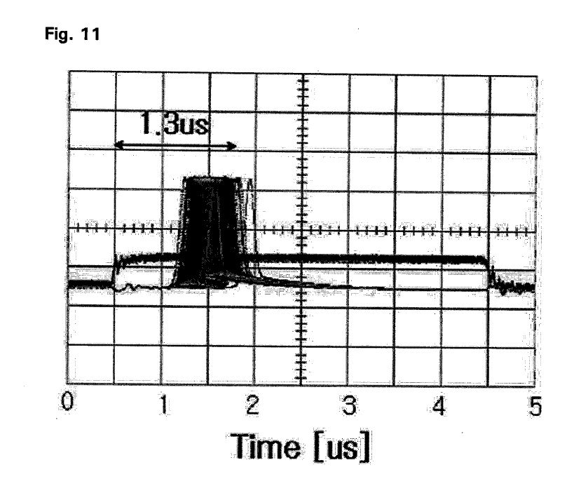

FIG. 11 is a graph illustrating characteristics of an address discharge generated in the plasma display panel according to an embodiment of the present invention. That is, FIG. 11 shows a time where an optical waveform of 500 address discharges that are consecutively generated is consistent. As shown in FIG. 11, a time from a time point where a pulse for a first address discharge is applied to the discharge cell to a time point where the last address discharge is generated is approximately 1.3 μs.

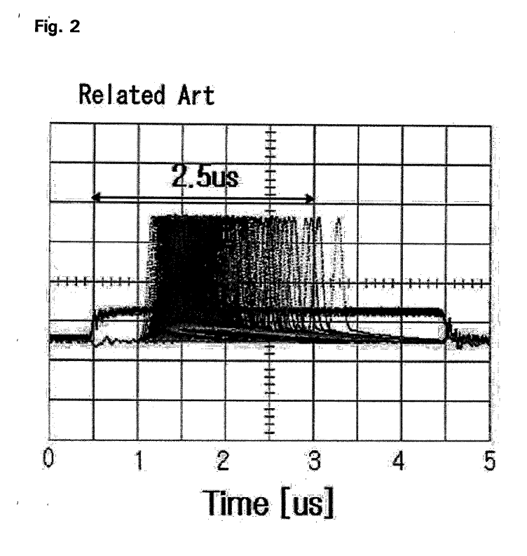

The time (approximately 1.3 μs) of the address discharge generated in the plasma display panel according to an embodiment of the present invention is less than a time (approximately 2.5 μs) of an address discharge generated in the related art plasma display panel of FIG. 2. In the electrode structure of the plasma display panel according to an embodiment of the present invention, a jitter characteristic improves. Furthermore, since an address discharge is accurately generated, a sustain discharge generated by the scan electrode 302 and the sustain electrode 303 is accurately generated. Furthermore, the plasma display panel according to an embodiment of the present invention can display images with a high picture quality through a more accurate address discharge and sustain discharge.

Furthermore, when the width of the scan bus electrode or the scan transparent electrode is 5% to 50% of the width of the sustain bus electrode or the sustain transparent electrode, a discharge voltage characteristic can be stabilized without change while improving a jitter characteristic.

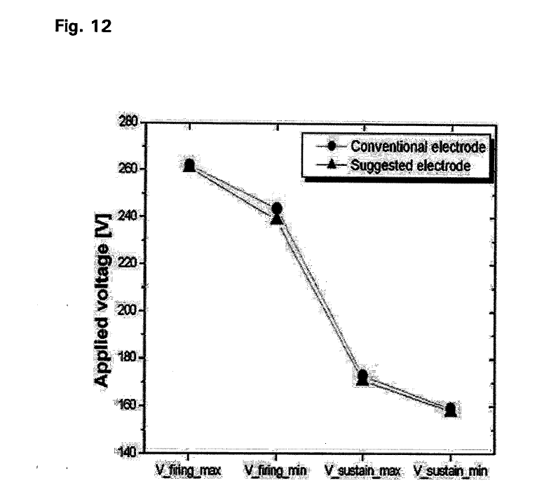

FIG. 12 is a graph illustrating the results of comparing a discharge voltage characteristic of the electrode structure of the plasma display panel according to an embodiment of the present invention and a discharge voltage characteristic of the plasma display panel in the related art. From FIG. 12, shows seen that a discharge firing voltage (V_firing_max, V_firing_min) characteristic and a sustain voltage level (V_sustain_max, V_sustain_min) characteristic during a sustain discharge in the electrode structure of the plasma display panel according to an embodiment of the present invention are almost the same as those in the electrode structure of the related art plasma display panel.

Furthermore, when the width of the scan bus electrode or the scan transparent electrode is 5% to 50% of the width of the sustain bus electrode or the sustain transparent electrode, a discharge current characteristic is stabilized without change while improving a jitter characteristic.

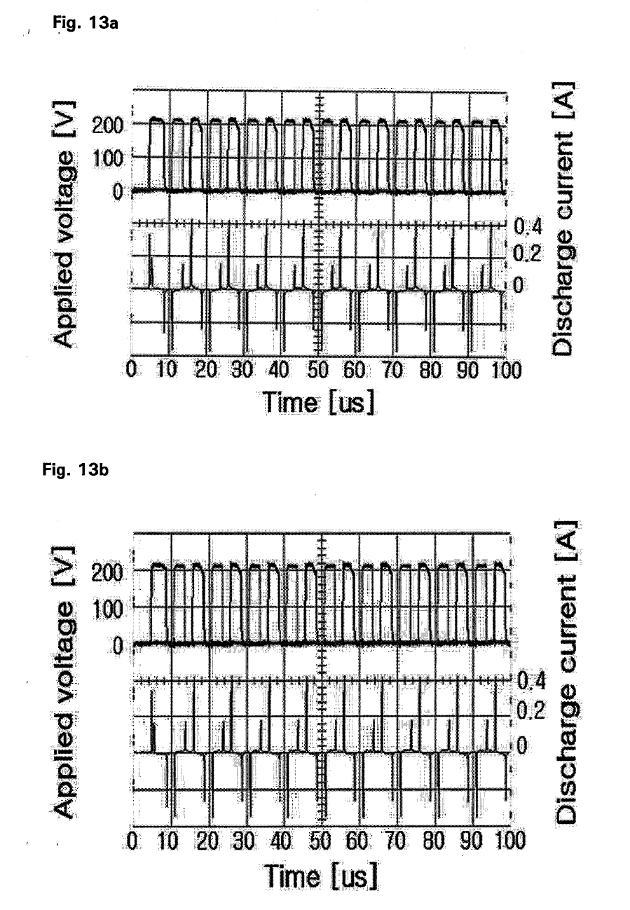

FIG. 13a illustrates a discharge current characteristic depending on a sustain voltage (applied voltage) in the electrode structure in the related art. FIG. 13b illustrates a discharge current characteristic depending on a sustain voltage (applied voltage) in the electrode structure of the present invention.

When a sustain voltage of approximately 200V is alternately applied to the scan electrode and the sustain electrode to generate a sustain discharge, a waveform of a discharge current, which is generated in the electrode structure of the plasma display panel shown in FIG. 13b according to an embodiment of the present invention, and a waveform of a discharge current, which is generated in the electrode structure of the plasma display panel shown in FIG. 13a in the related art are almost the same.

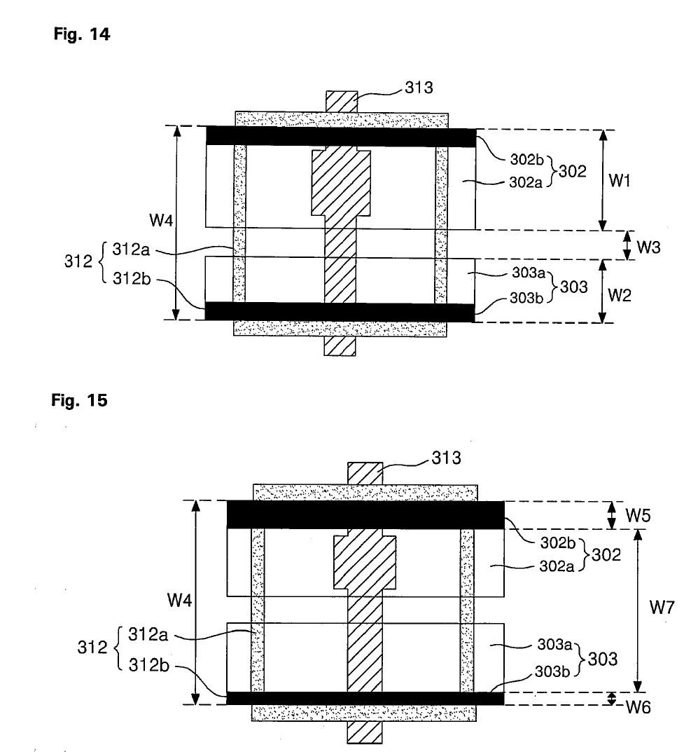

FIG. 14 shows an electrode structure of a plasma display panel according to a fourth embodiment of the present invention. The plasma display panel according to a fourth embodiment of the present invention comprises a scan electrode 302 and a sustain electrode 303 for sustaining the emission of a cell. The scan electrode 302 comprises a scan transparent electrode 302a and a scan bus electrode 302b, and the sustain electrode comprises a sustain transparent electrode 303a and a sustain bus electrode 303b.

As shown in FIG. 14, a first width (W1) in the longitudinal direction of an address electrode 313 of a scan transparent electrode 302a is wider than a second width (W2) in the longitudinal direction of the address electrode 313 of a sustain transparent electrode 303a in a region corresponding to the discharge cell. Furthermore, the address electrode 313 is projected toward a first barrier rib 312a in a region corresponding to the scan transparent electrode 302a. Accordingly, an area where the address electrodes 303 and the scan transparent electrode 302a are overlapped can increase.

If an area of the scan transparent electrode 302a is larger than the area of the sustain transparent electrode 303a and an overlapping area of the scan transparent electrode 302a and the address electrode 313, increases, a space where wall charges can be formed is secured. Therefore, an address discharge will be effectively generated and a jitter characteristic improves.

FIG. 15 shows an electrode structure of a plasma display panel according to a fifth embodiment of the present invention. As shown in FIG. 15, in a region within a discharge cell, a width (W1) in the longitudinal direction of an address electrodes 313 of a scan transparent electrode 302a is the same as a width of a sustain transparent electrode 303a, and a width (W5) in the longitudinal direction of the address electrode 313 of a scan bus electrode 302 is wider than a width (W6) in the longitudinal direction of address electrode 313 of a sustain bus electrode 303. Furthermore, the address electrode 313 is projected toward a first barrier rib 312a in a region corresponding to the scan transparent electrode 302a.

If an area of the scan bus electrode 302b is more than the area of the bus electrode 303b, and an overlapping area of the scan transparent electrode 302a and the address electrode 313 increases, a space where wall charges can be formed are secured. Therefore, an address discharge will be effectively generated and a jitter characteristic improves.

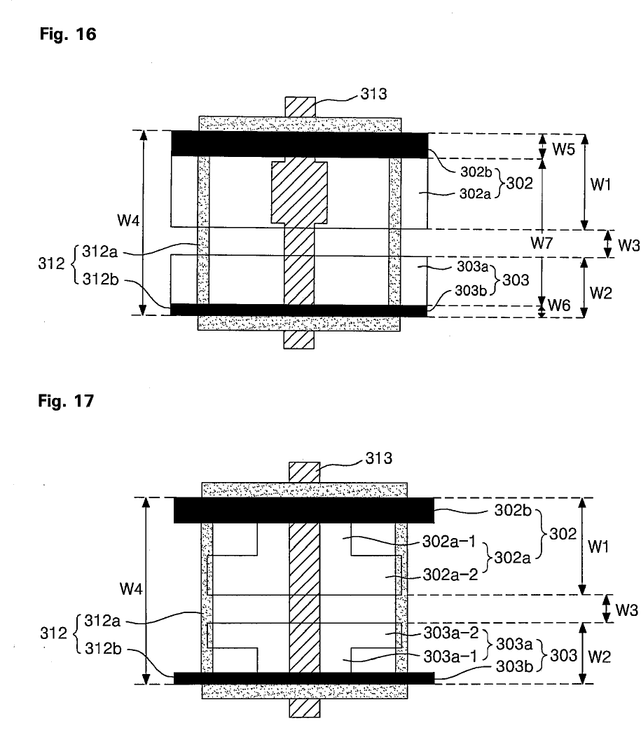

FIG. 16 shows an electrode structure of a plasma display panel according to a sixth embodiment of the present invention. As shown in FIG. 16, in a region within a discharge cell, a width (W1) in the longitudinal direction of an address electrodes 313 of a scan transparent electrode 302a is wider than a width of a sustain transparent electrode 303a, and a width (W5) in the longitudinal direction of the address electrode 313 of a scan bus electrode 302 is wider than a width (W6) in the longitudinal direction of the address electrode 313 of a sustain bus electrode 303. Furthermore, the address electrode 313 is projected toward a first barrier rib 312a in a region corresponding to the scan transparent electrode 302a.

If an area of the scan transparent electrode 302a and the scan bus electrode 302b is larger than the area of the sustain transparent electrode 303a and the sustain bus electrode 303b, and an overlapping area of the scan transparent electrode 302a and the address electrode 313, increases, a space where wall charges can be formed is secured. Therefore, an address discharge will be effectively generated and a jitter characteristic improves.

The exhaust groove that has been described with reference to FIG. 8 can be formed in a second barrier rib 312b of FIG. 16. If the exhaust groove is formed in the second barrier rib 312b, an exhaust characteristic of the plasma display panel improves. Furthermore, the exhaust groove can reduce capacitance formed by the second barrier rib 312b, lowering a driving voltage of the plasma display panel and enhancing driving efficiency.

FIG. 17 shows an electrode structure of a plasma display panel according to a seventh embodiment of the present invention. As shown in FIG. 17, a width of a scan bus electrode 302b is the same as the width of a sustain bus electrode 303b. A scan transparent electrode 302a comprises a first part scan electrode 302a-1 connected to the scan bus electrode 302b, and a second part scan electrode 302a-2 vertically connected to the first part scan electrode 302a-1 in a region within a discharge cell. A sustain transparent electrode 303a comprises a first part sustain electrode 303a-1 connected to the sustain bus electrode 303b, and a second part sustain electrode 303a-2 vertically connected to the first part sustain electrode 303a-I in the region within the discharge cell.

The sum (W1) of a width of the first part scan electrode 302a-1 and a width of the second part scan electrode 302a-2 is wider than the sum (W2) of a width of the first part sustain electrode 303a-1 and a width of the second part sustain electrode 303a-1.

Since an area of the scan transparent electrode 302a is larger than the area of the sustain transparent electrode 303a, a space in which wall charges can be formed is secured. Accordingly, an address discharge is effectively generated and a jitter characteristic improves.

The exhaust groove that has been described with reference to FIG. 8 can be formed in a second barrier rib 312b of FIG. 17. If the exhaust groove is formed in the second barrier rib 312b, an exhaust characteristic of the plasma display panel improves. Furthermore, the exhaust groove can reduce capacitance formed by the second barrier rib 312b, lowering a driving voltage of the plasma display panel and enhancing driving efficiency.

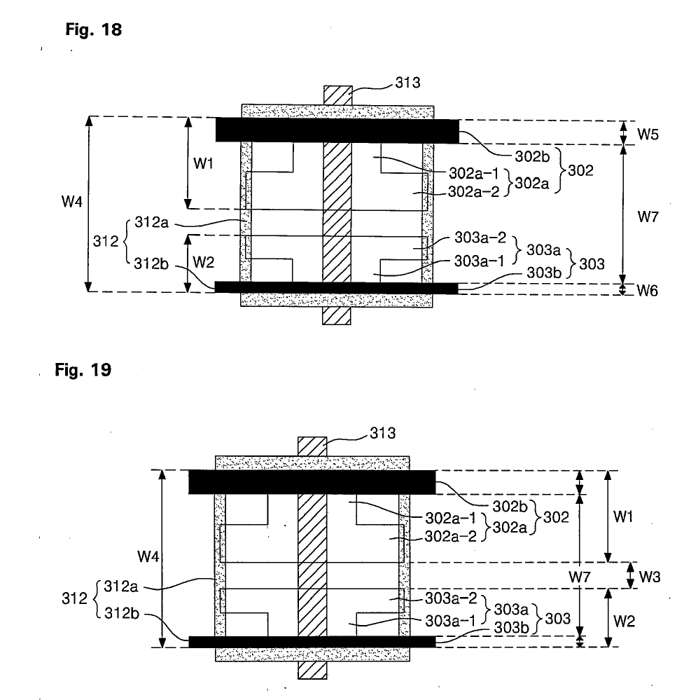

FIG. 18 shows an electrode structure of a plasma display panel according to an eighth embodiment of the present invention. As shown in FIG. 18, a scan transparent electrode 302a comprises a first part scan electrode 302a-1 connected to a scan bus electrode 302b and a second part scan electrode 302a-2 vertically connected to the first part scan electrode 302a-1 in a region within a discharge cell. A sustain transparent electrode 303a comprises a first part sustain electrode 303a-1 connected to a sustain bus electrode 303b and a second part sustain electrode 303a-2 vertically connected to the first part sustain electrode 303a-1 in the region within the discharge cell.

The sum (W1) of a width of the first part scan electrode 302a-1 and a width of the second part scan electrode 302a-2 is the same as the sum (W2) of a width of the first part sustain electrode 303a-1 and a width of the second part sustain electrode 303a-1. Furthermore, a width (W5) of the scan bus electrode 302b is larger than a width (W6) of the sustain bus electrode 303b.

Since an area of the scan transparent electrode 302a is larger than the area of the sustain transparent electrode 303a, a space in which wall charges can be formed can be secured. Accordingly, an address discharge can be effectively generated and a jitter characteristic improves.

FIG. 19 shows an electrode structure of a plasma display panel according to a ninth embodiment of the present invention. As shown in FIG. 19, a scan transparent electrode 302a comprises a first part scan electrode 302a-1 connected to a scan bus electrode 302b and a second part scan electrode 302a-2 vertically connected to the first part scan electrode 302a-1 in a region within a discharge cell. A sustain transparent electrode 303a comprises a first part sustain electrode 303a-1 connected to a sustain bus electrode 303b and a second part sustain electrode 303a-2 vertically connected to the first part sustain electrode 303a-1 in the region within the discharge cell.

The sum (W1) of a width of the first part scan electrode 302a-1 and a width of the second part scan electrode 302a-2 is more than the sum (W2) of a width of the first part sustain electrode 303a-1 and a width of the second part sustain electrode 303a-1. A width (W5) of the scan bus electrode 302b is more than a width (W6) of the sustain bus electrode 303b.

Since an area of the scan transparent electrode 302a is larger than the area of the sustain transparent electrode 303a, a space in which wall charges can be formed can be secured. Accordingly, an address discharge can be effectively generated and a jitter characteristic improves.

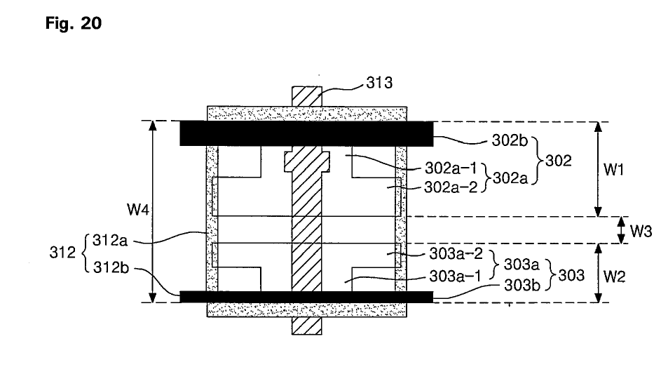

FIG. 20 shows an electrode structure of a plasma display panel according to a tenth embodiment of the present invention. As shown in FIG. 20, a width of a scan bus electrode 302b and a width of the sustain bus electrode 303b are the same. A scan transparent electrode 302a comprises a first part scan electrode 302a-1 connected to the scan bus electrode 302b and a second part scan electrode 302a-2 vertically connected to the first part scan electrode 302a-1 in a region within a discharge cell. A sustain transparent electrode 303a comprises a first part sustain electrode 303a-1 connected to a sustain bus electrode 303b and a second part sustain electrode 303a-2 vertically connected to first part sustain electrode 303a-1 in the region within the discharge cell.

The sum (W1) of a width of the first part scan electrode 302a-1 and a width of the second part scan electrode 302a-2 is more than the sum (W2) of a width of the first part sustain electrode 303a-1 and a width of the second part sustain electrode 303a-1.

The address electrode 313 is projected toward the first barrier ribs 312a in a region corresponding to the scan bus electrode 302b.

Therefore, since an area of the scan transparent electrode 302a is larger than the area of the sustain transparent electrode 303a, an area where the scan transparent electrode 302a and the address electrode 313 overlap increases. Accordingly, a space in which wall charges can be formed can be secured. As a result, an address discharge can be effectively generated and a jitter characteristic improves.

The embodiments of the invention being thus described may be varied in many ways. Such variations are not to be regarded as a departure from the spirit and scope of the invention, and all such modifications as would be obvious to one skilled in the art are intended to be included within the scope of the following claims.

What is claimed is:

1. A plasma display panel comprising:
a plurality of barrier ribs disposed on a substrate to form a discharge cell;
a scan electrode with a first area in a region within the discharge cell; and
a sustain electrode with a second area smaller than the first area in the region within the discharge cell.

2. The plasma display panel of claim 1, wherein a first width of the scan electrode in the first portion of the discharge cell is wider than a second width of the sustain electrode in the second portion of the discharge cell.

3. The plasma display panel of claim 2, wherein the difference between the first width and the second width is 5% or more to 50% or less.

4. The plasma display panel of claim 2, wherein the difference between the first width and the second width is 10% or more to 30% or less.

5. The plasma display panel of claim 2, wherein the first width is a maximum value of a width of the scan electrode and the second width is a maximum value of a width of the sustain electrode.

6. The plasma display panel of claim 2, wherein the scan electrode comprises a scan transparent electrode and the sustain electrode comprises a sustain transparent electrode, and
the width of the scan transparent electrode is the first width, and the width of the sustain transparent electrode is the second width.

7. The plasma display panel of claim 6, wherein the plurality of barrier ribs comprise first barrier ribs that partition the discharge cell and an adjacent discharge cell in which different phosphors are formed, and wherein the scan transparent electrode and the sustain transparent electrode protrude in a direction toward the first barrier ribs.

8. The plasma display panel of claim 1, wherein the plurality of barrier ribs comprise second barrier ribs that partition the discharge cell and an adjacent discharge cell in which the same phosphor is formed, and wherein an exhaust groove is formed on the second barrier ribs.

9. The plasma display panel of claim 2, wherein the plurality of barrier ribs comprise first barrier ribs that partition the discharge cell and an adjacent discharge cell in which different phosphors are formed, the plasma display panel further comprises an address electrode intersecting the scan electrode and the sustain electrode, and the address electrode protrudes in a direction of the first barrier ribs in a region corresponding to the scan electrode.

10. The plasma display panel of claim 1, wherein the scan electrode comprises a scan bus electrode with the first area in the region within the discharge cell, the sustain electrode comprises a sustain bus electrode with the second area in the region within the discharge cell, and the scan bus electrode and the sustain bus electrode form a discharge gap.

11. The plasma display panel of claim 10, wherein a first width of the scan bus electrode in the region within the discharge cell is wider than a second width of the sustain bus electrode in the region within the discharge cell.

12. The plasma display panel of claim 11, wherein the difference between the first width and the second width is 5% or more to 50% or less.

13. The plasma display panel of claim 11, wherein the difference between the first width and the second width is 10% or more to 30% or less.

14. The plasma display panel of claim 11, wherein the plurality of barrier ribs comprises second barrier ribs that partition discharge cell and an adjacent discharge cell in which the same phosphor is formed, and an exhaust groove is formed on the second barrier ribs.

15. The plasma display panel of claim 11, wherein the plasma display panel further comprises a scan transparent electrode connected to the scan bus electrode, and further comprises an address electrode intersecting the scan bus electrode and the scan transparent electrode, the plurality of barrier ribs comprise first barrier ribs that partition the discharge cell and an adjacent discharge cell in which different phosphors are formed, and the address electrode protrudes in a direction toward the first barrier ribs in a region corresponding to the scan bus electrode and the scan transparent electrode.

16. A plasma display panel comprising:
a plurality of barrier ribs disposed on a substrate to form a discharge cell;
a scan electrode comprising a scan bus electrode with a first area and a scan transparent electrode with a second area in a region within the discharge cell; and
a sustain electrode comprising a sustain bus electrode with a third area smaller than the first area and a sustain transparent electrode with a fourth area smaller than the second area in the region within the discharge cell.

17. The plasma display panel of claim 16, wherein the plurality of barrier ribs comprises second barrier ribs that partition the discharge cell and an adjacent discharge cell in which the same phosphor is formed, and wherein an exhaust groove is formed on the second barrier ribs.

18. A plasma display panel comprising:
a plurality of barrier ribs disposed on a substrate to form a discharge cell;
a scan bus electrode formed in a region within the discharge cell;
a scan transparent electrode comprising a first portion scan electrode connected to the scan bus electrode and a second portion scan electrode vertically connected to the first portion scan electrode;
a sustain bus electrode formed in the region within the discharge cell; and
a sustain transparent electrode comprising a first portion sustain electrode connected to the sustain bus electrode and a second portion sustain electrode vertically connected to the first portion sustain electrode,
wherein a total width of the first portion scan electrode and the second portion scan electrode is wider than the total width of the first portion sustain electrode and the second portion sustain electrode.

19. The plasma display panel of claim 18, wherein the plurality of barrier ribs comprise first barrier ribs that partition the discharge cell and an adjacent discharge cell in which different phosphors are formed, the plasma display panel further comprises an address electrode intersecting the scan transparent electrode, and the address electrode protrudes in a direction toward the first barrier ribs in a region corresponding to the scan transparent electrode.

20. The plasma display panel of claim 18, wherein the plurality of barrier ribs comprises second barrier ribs that partition the discharge cell and an adjacent discharge cell in which the same phosphor is formed, and wherein an exhaust groove is formed on the second barrier ribs.
